(19) United States
(12) Patent Application Publication
(10) Pub. No.: US 2006/0164509 A1
(43) Pub. Date: Jul. 27, 2006

(54) Stereo camera/viewer

(76) Inventors: Andrew Marshall, Dallas, TX (US); Tito Gelsomini, Plano, TX (US); Harvey Edd Davis, Trenton, TX (US)

Correspondence Address: TEXAS INSTRUMENTS INCORPORATED, P O BOX 655474, M/S 3999, DALLAS, TX, 75265, US

(21) Appl. No.: 11/300,259

(22) Filed: Dec. 14, 2005

Related U.S. Application Data
(60) Provisional application No. 60/636,331, filed on Dec. 14, 2004.

(51) Int. Cl. H04N 5/225; H04N 13/00

(52) U.S. Cl. 348/42

(57) ABSTRACT

A stereoscopic camera/viewer has a camera section and viewer section. The camera section has two digital imaging and display subsystems, with imaging lenses and display lenses oriented on parallel axes, spaced at human eye interpupillary distance. Photosensitive image sensors generate M×N pixel image data for each image, which is compressed using JPEG, MPEG, or similar algorithms in a compression engine Audio/Video (A/V) Coder. The separate images are stored in nonvolatile (NV) Memory. On playback, image pairs are read out of memory, decompressed in the A/V Decoder, and displayed on display elements. The image taken by the left and right lenses appears on respective ones of left and right display elements, for viewing by separate eyes of a viewer to give a 3D effect. Microphones and speakers support audio recording and playback. Wireless receipt or transmission of image data is supported.

### CROSS-REFERENCE TO RELATED APPLICATION

This application claims priority under 35 U.S.C. 119 of provisional application Ser. No. 60/636,331, filed Dec. 14, 2004, the entirety of which is incorporated herein by reference.

### FIELD OF THE INVENTION

This disclosure relates to electronic imaging in general; and, in particular, to a digital camera/viewer having for taking stereoscopic pictures or videos.

### BACKGROUND

Digital cameras have been widely adopted by both amateur and professional photographers. As resolution of digital cameras increases, and the cost of non-volatile memory cards decreases, more photographers are moving from film to electronic imaging.

The resolution of many current digital cameras ranges from 2.1 megapixels (MP) to 4.2 MP. As digital camera technology advances, cameras with higher resolution are becoming more common. A 2.1 MP camera captures an image as an array of 1600×1200 (1600 horizontal by 1200 vertical) pixels. A 4.2 MP camera has an image sensor with a 2272×1704 array of pixels.

Data from an image sensor of a digital camera is typically compressed according to a JPEG (joint photographic experts group) defined standard to decrease the size of the image file, and the file is stored on a non-volatile (NV) memory card in the camera. Image files can then be downloaded to a computer, emailed to others, modified to enhance the image, and printed on a printer. The resulting viewable computer screen display or hardcopy print is a two-dimensional image.

In many cases it would be desirable to enhance the realism of the image by making it appear three dimensional (3D). Known art 3D film cameras typically employ two lenses parallel to each other and spaced apart by a distance that approximates the distance between human eyes (interpupillary distance). Two pictures are taken of each scene, from the slightly different perspectives due to the offset lenses. After processing, the two prints or transparency slides of each stereo pair can be viewed simultaneously, separately by each eye, while held in spaced alignment at the interpupillary distance in, for example, a cardboard or plastic holder; thereby, giving a 3D perception.

These 3D pictures can be viewed in several ways. A low-cost approach is to view them with a slide viewer having two parallel lens systems, one for each eye, separated by the interpupillary distance. The image from the left slide is seen only by the left eye, and the right slide is seen only by the right eye. Both slide transparencies are illuminated from behind by artificial or natural light. The viewer perceives a lifelike 3D scene, having increased depth perception and realism over a 2D image. One very popular and successful application of 3D imaging has been the View Master™ stereoscopic display apparatus, made popular as a children's toy. Multiple 3D stereo pairs of slides are held in a circular cardboard card which is placed in a viewer as described above. A lever is pushed to rotate the circular card a precise amount to advance to the next image pair.

An alternative for viewing 3D images is projection. As with a viewer held to the eyes, a 3D projector must project two images, respectively corresponding to each of the stereo pair of images. However, if both images are projected onto a common screen, the left and right eyes each see both images and no perception of depth is created unless some filtering mechanism is employed between the screen and the eyes. One way this has been done is through color differentiation, projecting each image in a different color and using color filter (for example, red and green filter) eyewear to filter respective ones of the stereo images to each eye. Filtering by color obviously limits the true color representation in the perceived 3D image.

Polarization may also be employed, such as using two projectors to project the separate images. In this arrangement, polarizing filters may be placed over each projection lens to separate the left and right images. The filters typically have a relative polarization of 90 degrees between filters. The viewer then looks at the screen through eyewear that places corresponding filters in front of the eyes, with like 90 degree relative polarization angle between left and right eye filters. The polarization of the eyewear causes the left eye to see only the left eye image from one projection lens, and the right eye to see only the right eye image from the other projection lens. A special projection screen is also commonly used, which reflects the light from the projector without significantly affecting polarization. Polarization provides better color spectrum but because of the complexity and cost of projection, hand-held viewers as described above remain a more popular way to view stereo images.

The relatively high cost of film, processing, and specialized mounting of slide pairs has limited the acceptance and usage of stereo photography. The requirement for both a camera and specialized viewer (or much more complex projection system) further limits popularity. A stereoscopic photography system combining the many advantages of digital photography in a single relatively low-cost camera/viewer would therefore likely appeal to photographers of every age.

### SUMMARY

The disclosed camera/viewer provides an apparatus and method for stereoscopic digital photography, enabling both still and motion image picture capture, and further enabling viewing of stereoscopic images using the same device.

In described embodiments, two identical lens/imager subsystems are mounted with both lenses on substantially parallel axes, spaced by an estimated average human interpupillary distance. The image data from each imager is separately compressed into a suitable format (for example JPEG standard format) for storage on a solid-state memory card. Two LCD or other suitable display elements are located in co-planar, likewise interpupillary distance spacing locations, viewable from a rear of the device. Separate lens systems magnify the image of each display panel and keep the two images separated. When the lenses are held up to the eyes, the two images merge into a stereoscopic image of the scene photographed. The same display screens and lenses are used as a viewfinder when taking pictures.

The resulting stereoscopic camera/viewer provides the benefits of digital photography, including low-cost image storage, immediate review of images taken, and support of both still and motion pictures (with sound). It adds the increased realism of 3D imaging, and serves as both the camera and the preferred viewing mechanism.

### BRIEF DESCRIPTION OF THE DRAWINGS

FIG. 1 is perspective view of an example embodiment of a stereo digital camera/viewer in accordance with principles of the invention;

FIG. 2 is a block diagram of an example implementation of the camera/viewer of FIG. 1.

Throughout the drawings, like elements are referred to by like numerals.

### DETAILED DESCRIPTION OF THE EMBODIMENTS

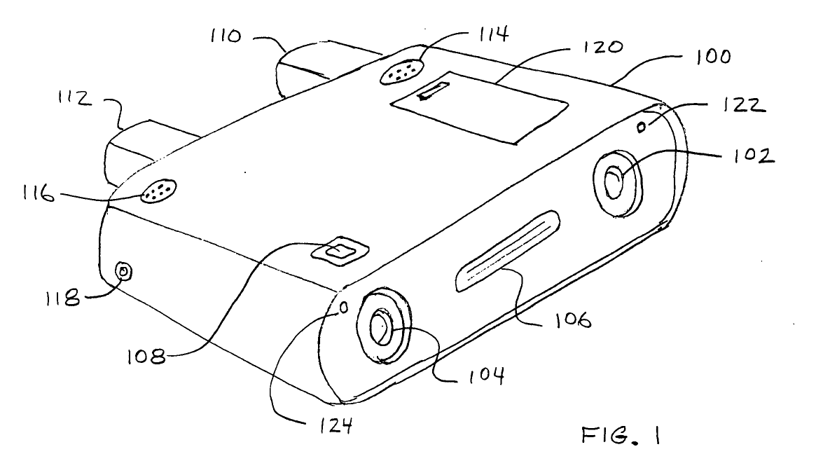

In FIG. 1, camera/viewer 100 has two lenses 102, 104, typically fixed-focal-length and fixed-focus, for low cost and good matching lens-to-lens. Such fixed-focus lenses are practical for stereoscopic photography which has an optimal camera to subject distance of approximately 10 to 20 feet for best depth perception. Flash 106 is used for indoor photography. Switch 108 is pressed to capture an image (the “shutter release”). Eyepiece lens assemblies 110, 112 magnify the images from internal LCD, OLED or other display devices, which are spaced at the average human interpupillary distance.

Supporting video capture with sound, microphones 122, 124 are positioned typically on the front or top of the camera and spaced to enable stereo sound recording. Playback of recorded sounds is through speakers 114, 116, or optionally through stereo headphones connected to jack 118.

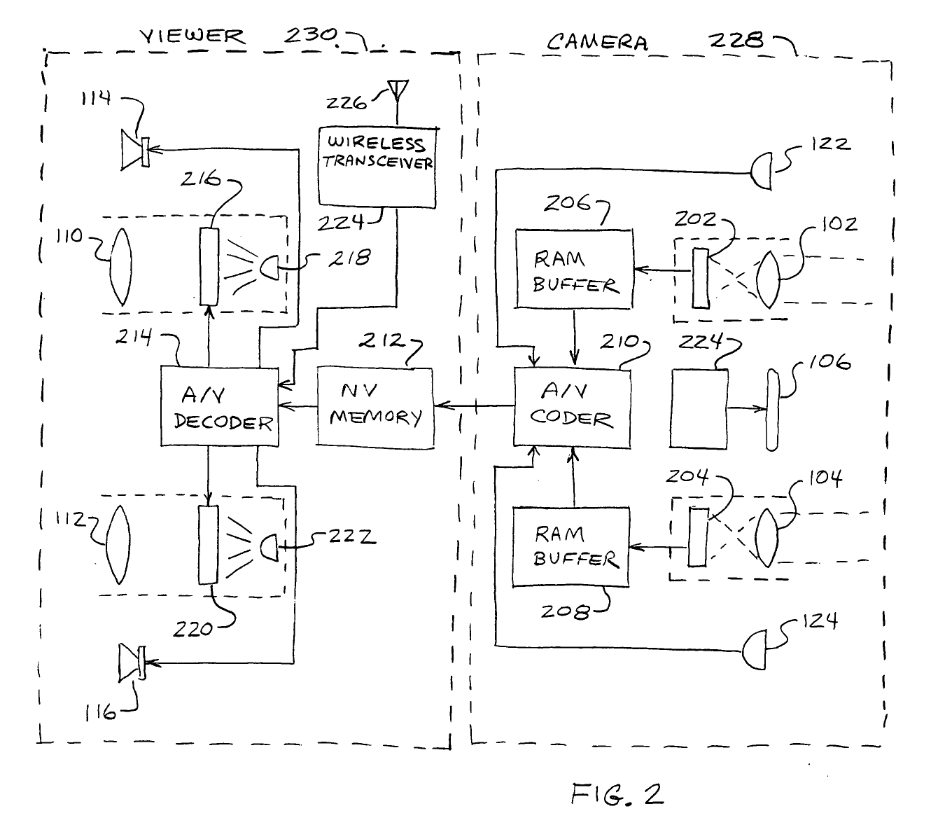

FIG. 2 is a block diagram showing the subsystems within the disclosed camera/viewer. The operation of the left and right imaging and audio chains is identical. Parenthetical drawing numbers refer to the corresponding right side object.

In camera section 228, light from the objects being photographed is focused by lens 102 (104) onto imaging array (CCD, CMOS, or other) 202 (204), which is a M×N pixel array of photosensitive elements. Array 202 (204) can act as an electronic shutter, further reducing mechanical complexity and cost of the camera/viewer. After a picture is taken, image data from each pixel of array 202 (204) is read out, digitized, and temporarily stored in buffer random access memory (RAM) 206 (208). Once all data is transferred to RAM 206 (208), the data from each RAM, in turn, is passed to audio/video (A/V) coder 210, which compresses the image data in a suitable format such as a JPEG standard format. By compressing in turn the image data from the left and right buffer RAM's, a single image compression engine can be used. Sound signals from microphone 122 (124) are also digitized and compressed. It will be appreciated that embodiments utilizing common elements for elements 202, 204 or 206, 208 are possible.

Audio and video (A/V) data is then passed to non-volatile (NV) memory 212 in viewer section 230 for storage. Each stereoscopic image is actually two separately-stored images, one from right, one from left. For video, stereo pairs of image frames are taken and stored in rapid succession, for example at 15 or more image frame pairs per second. Memory 212 may be on a removable card, facilitating easy change. Once the A/V data is stored in memory 212, power may be removed from the system without losing the image or sound data.

When playback of an image or video sequence of image frames is desired, corresponding data is read out of NV memory 212 and passed to AN decoder 214. Decoder 214 processes (decompresses) image and sound data into a format usable by a display device 216 (220) and speaker 114 (116). Display device 216 (220) can be a small liquid crystal display (LCD) or optical light emitting diode (OLED) display, able to generate a full color, high resolution image. In the case of an LCD display, light from backlight 218 (222) can be passed through display 216 (220), which modifies intensity and color, on a pixel-by-pixel basis, to create the final image. An OLED display requires no such backlighting. Lenses 110 and 112 are placed near the viewer's eye, and magnify the images on displays 216 and 220. The lenses may be chosen so that resulting stereoscopic color image or video appears to float in space a few feet in front of the viewer. Focusing capability can be readily provided for lens 110 (112).

Not shown, but known to those skilled in the art, are other camera subsystems such as power supply, user input devices e.g. key switches, and a microcontroller providing the human interface to the camera/viewer and controlling overall system operation.

A single, handheld housing thus combines a stereoscopic camera for capturing images/audio/video, and a viewer for displaying these images/audio/video or other pre-stored images/audio/video. For example, memory cards 212 can be pre-programmed with 3D images of travel destinations, national parks, comic strip characters, etc, much like the disks used in manually operated View Master™ devices, already described. Additionally, video/audio of movies, cartoons, television shows, instructional videos, or other programming can also be pre-stored and marketed to users of the device. The effectiveness of modern video/audio compression, such as MPEG4 format compression, allows many minutes of content to be stored on a low-cost memory card.

An alternative embodiment of the disclosed camera/viewer uses matched variable-focal-length zoom lenses in place of the simpler fixed-focal-length lenses, and may include known auto-focus capabilities.

Yet another alternative embodiment provides only the viewer section 230, enabling viewing of 3D still and motion images, with sound. Image, video and/or audio data is either contained on removable pre-programmed memory card 212, or is received by wireless transceiver 224. Inclusion of transceiver 224 and antenna 226, using known 802.11 or similar wireless LAN technology, enables images or video/audio content to be streamed from a media server in the home, automobile, or other location to one or more such viewers. If produced at low cost, this embodiment would likely be a popular media viewer for children and teens. Without the requirement to support the camera section, and with further miniaturization of electronic components, an eyeglass-like version of such a viewer is feasible.

The illustrated embodiment thus shows a stereoscopic camera/viewer (100) has a camera section (228) and viewer section (230). Camera section (228) has two digital imaging and display subsystems, with imaging lenses (102), (104) and display lenses (110), (112) oriented on parallel axes spaced at approximately the average human interpupillary distance. Photosensitive image sensors (202), (204) generate M×N pixel image data for each image, which is compressed using JPEG, MPEG, or similar algorithms in compression engine Audio/Video (A/V) Coder (210). The separate images are then stored in nonvolatile (NV) Memory (212). A single pair of images is taken and stored for a still photo; a series of image pairs is captured, at a rate typically 15 to 30 pairs per second, for moving images (video). On playback, image pairs are read out of memory (212), decompressed in A/V Decoder (214), and displayed on display elements (216), (220). The image taken by the left lens and sensor appears on the left display, while that taken by the right lens and sensor appears on the right display. These images are magnified by viewing lenses (110), (112) and appear to the viewer as a much larger stereoscopic image floating in front of the viewer. NV memory (212) is removable to enable unlimited image storage, and also to enable use of pre-programmed memory cards having movies, cartoons, instructional video, etc. Microphones (122), (124) and speakers (114), (116) support audio recording and playback. Compressed image or A/V data is alternatively received by a wireless receiver or transceiver such as (802.11).

In one aspect of implementation of the invention, a combination stereoscopic camera and viewer comprises two lenses and two image sensor arrays on parallel axes and spaced at the typical human interpupillary distance, coupled to image compression and storage elements, for capturing stereoscopic pairs of images or stereoscopic video from two slightly different perspectives. The apparatus also has an image decompression element and two image display elements with corresponding magnifying lenses, also on parallel axes and spaced at the typical human interpupillary distance. The apparatus can be used in a manner analogous to the use of a binocular or manually operated View Master™ device for viewing stereoscopic images or video images. The may be a removable memory element for storage of such stereoscopic images or video images, to facilitate viewing of images or video taken by this camera or another.

In another aspect of implementation, a stereoscopic viewer comprises a removable memory element for storing, in compressed format such as MPEG format, stereoscopic or non-stereoscopic images or video images. A decompression element for decompressing such data into images and/or audio is provided, as are two image display elements with corresponding magnifying lenses, on parallel axes and spaced at the typical human interpupillary distance. The apparatus may be used in a manner analogous to a binocular or View Master™ device for viewing stereoscopic images or video images contained on the removable memory card.

In another aspect of implementation, a stereoscopic viewer comprises a wireless transceiver or receiver such as employ an 802.11 standard wireless transmission scheme. The apparatus is configured and adapted to receives stereoscopic or non-stereoscopic image or audio/video data in compressed format, such as defined by JPEG or MPEG standards. A decompression element is provided for decompressing such data into images and/or audio/video data. Two image display elements with corresponding magnifying lenses, on parallel axes and spaced at the typical human interpupillary distance, are also provided. The apparatus may be used in a manner analogous to the use of a binocular or View Master™ device for viewing the received stereoscopic images or audio/video data.

Those skilled in the art to which the invention relates will appreciate that yet other additions, deletions, substitutions and modifications can be made to the described embodiments, without departing from the scope of the invention as defined by the specification and claims hereof.

1. (canceled)

2. A stereoscopic camera, comprising:
a handheld housing;
left and right lenses mounted on said housing and having optical axes spaced at interpupillary distance for viewing respective left and right eye images of a scene;
left and right image sensor arrays mounted on said housing in optical communication for respectively receiving said left and right eye images viewed by said lenses; and
circuitry mounted on said housing for processing said left and right eye images received by said image sensor arrays into digitized format; and
a memory mounted on said housing for storing said digitized left and right eye images.

3. The camera of claim 2, wherein said memory is a removable memory card.

4. The camera of claim 2, further comprising left and right microphones mounted on said housing for receiving respective left and right audio signals from said viewed scene; said circuitry being further configured and adapted for processing said left and right audio signals into digitized format; and said memory being further configured and adapted for storing said digitized left and right audio signals.

5. The camera of claim 2, wherein said circuitry is further adapted and configured to provide image compression of said digitized images.

6. The camera of claim 2, further comprising:
circuitry mounted on said housing for retrieving said stored digitized images from said memory and for reprocessing said retrieved images into reconstructed left and right eye image signals; and
left and right image display elements mounted on said housing for receiving said reconstructed image signals and for displaying said received signals along optical axes spaced at interpupillary viewing distance for viewing by respective left and right eyes of a user.

7. The camera of claim 6, wherein said processing circuitry is further adapted and configured to provide image compression of said digitized images; and said reprocessing circuitry is further adapted and configured to provide decompression of said digitized images.

8. The camera of claim 6, further comprising left and right microphones mounted on said housing for receiving respective left and right audio signals from said viewed scene; said processing circuitry being further configured and adapted for processing said left and right audio signals into digitized format; said memory being further configured and adapted for storing said digitized left and right audio signals; and said reprocessing circuitry being further configured and adapted for retrieving said stored digitized audio signals from said memory and for reprocessing said retrieved audio signals into reconstructed left and right audio channel signals.

9. The camera of claim 8, further comprising left and right speakers mounted on said housing for receiving said reconstructed audio signals and for playing said received audio signals for listening by a user.

10. A stereoscopic image viewer, comprising:
a handheld housing;
a memory mounted on said housing storing digitized left and right eye images corresponding to left and right views of a scene taken along optical axes spaced at interpupillary distance;
circuitry mounted on said housing for retrieving said stored digitized images from said memory and for reprocessing said retrieved images into reconstructed left and right eye image signals; and
left and right image display elements mounted on said housing for receiving said reconstructed image signals and for displaying said received signals along optical axes spaced at interpupillary viewing distance for viewing by respective left and right eyes of a user.

11. The viewer of claim 10, wherein said memory is a removable memory card.

12. The viewer of claim 10, wherein said memory is further adapted and configured for storing compressed digitized images; and said reprocessing circuitry is further adapted and configured to provide decompression of said digitized images.

13. The viewer of claim 10, wherein said memory is further adapted and configured for storing digitized audio signals corresponding to respective left and right audio signals received from said viewed scene; and said reprocessing circuitry is further configured and adapted for retrieving said stored digitized audio signals from said memory and for reprocessing said retrieved audio signals into reconstructed left and right audio channel signals.

14. The viewer of claim 13, further comprising left and right speakers mounted on said housing for receiving said reconstructed audio signals and for playing said received audio signals for listening by a user.

15. A stereoscopic camera, comprising:
a handheld housing;
left and right lenses mounted on said housing and having optical axes spaced at interpupillary distance for viewing respective left and right eye images of a scene;
left and right image sensor arrays mounted on said housing in optical communication for respectively receiving said left and right eye images viewed by said lenses; and
circuitry mounted on said housing for processing said left and right eye images received by said image sensor arrays into compressed digitized format; and
a memory mounted on said housing for storing said compressed digitized left and right eye images;
circuitry mounted on said housing for retrieving said stored compressed digitized images from said memory and for reprocessing said retrieved images into decompressed reconstructed left and right eye image signals; and
left and right image display elements mounted on said housing for receiving said reconstructed image signals and for displaying said received signals along optical axes spaced at interpupillary viewing distance for viewing by respective left and right eyes of a user.

16. The camera of claim 15, wherein said memory is a removable memory card.

17. The camera of claim 15, further comprising left and right microphones mounted on said housing for receiving respective left and right audio signals from said viewed scene; said processing circuitry being further configured and adapted for processing said left and right audio signals into digitized format; said memory being further configured and adapted for storing said digitized left and right audio signals; and said reprocessing circuitry being further configured and adapted for retrieving said stored digitized audio signals from said memory and for reprocessing said retrieved audio signals into reconstructed left and right audio channel signals.

18. The camera of claim 17, further comprising left and right speakers mounted on said housing for receiving said reconstructed audio signals and for playing said received audio signals for listening by a user.
